(19) United States
(12) Patent Application Publication
(10) Pub. No.: US 2022/0349803 A1
(43) Pub. Date: Nov. 3, 2022

(54) METHOD AND APPARATUS FOR PARTICLE DETECTION IN TURBID OR CLEAR MEDIUM

(71) Applicant: Soreq Nuclear Research Center, Yavne (IL)

(72) Inventors: Bruno Sfez, Yavne (IL); Neta Arad-Vosk, Yavne (IL)

(73) Assignee: Soreq Nuclear Research Center, Yavne (IL)

(21) Appl. No.: 17/633,261

(22) PCT Filed: Aug. 6, 2020
(86) PCT No.: PCT/IB2020/057424

§ 371 Date: Feb. 7, 2022

Related U.S. Application Data
(60) Provisional application No. 62/883,712, filed on Aug. 7, 2019.

(51) Int. Cl. G01N 15/06; G01N 21/31; G01N 21/51; G06N 3/08

(52) U.S. Cl. CPC G01N 15/06; G01N 21/31; G01N 21/51; G06N 3/08; G01N 2201/1296; G01N 2021/4723

(57) ABSTRACT

An apparatus for generating a two dimensional map representative of a turbid or clear medium (11) includes a system (12) for generating incoherent light within a medium (11), a light collecting system (13) that is movable or stationary relative to the medium (11) being analyzed and that is arranged for collecting light exiting the medium (11), and a spectrum analyzer (14) configured to determine spectrum data of the light exiting the turbid medium (11) and to transmit the spectrum data to a computing unit (15). The computing unit (15) is configured to generate a two dimensional map, in which one dimension of the map is wavelength and a second dimension is a position of the light collecting system (13). The invention is also direct-ed to a method for classifying media using the two dimensional map generated with the apparatus. The method comprises steps of feeding and training neural networks and using the trained neural networks to classify unknown media.

### FIELD OF THE INVENTION

The present invention relates generally to determination of the composition of an optically turbid medium.

### BACKGROUND OF THE INVENTION

The determination of the composition of an optically turbid or clear medium is a complex issue for several reasons. The scattering of light in the particles that compose the turbid medium is strongly dependent on the light wavelength and therefore using only light spectrum is not sufficient to determine the medium composition.

On the other hand, collecting and measuring light at different positions or angles gives information that is difficult to exploit properly. This is due to the fact that reconstructing the interior of a scattering medium, also known as inverse scattering problem, is an ill-posed problem that yields many solutions. Choosing the correct solution generally requires additional information, intuition and skills that are related to the exact problem at hand.

### SUMMARY

The present invention provides novel methods for the determination of the composition of an optically turbid or clear medium, that is, liquid or solid materials that have a certain level of turbidity. In one aspect of the invention, the method measures two-dimensional maps that present some signature of the medium, and uses machine learning techniques in order to determine the composition of the medium, instead of inverse scattering methods.

In one embodiment, the method includes illuminating a turbid or clear medium and collecting light all around (at different observation angles around the medium). Light collected is then analyzed spectrally. Therefore, a two-dimensional map is obtained, where one axis is the wavelength and the other one is the observation angle. Using machine learning algorithms and proper training on a large number of such maps obtained using materials with different compositions, it is possible to determine at least partially the composition of an unknown material.

There is provided in accordance with an embodiment of the invention an apparatus for generating a two dimensional map representative of a turbid or clear medium, including a system that generates light within a medium, a light collecting system that is movable relative to the medium being analyzed and that collects light exiting the medium, and a spectrum analyzer configured to determine spectrum data of the light exiting the medium and to transmit the spectrum data to a computing unit, wherein the computing unit is configured to generate a two dimensional map, wherein one dimension of the map is wavelength and a second dimension is a position of the light collecting system.

The light collecting system may be movable along a curved path and/or linearly movable. The light may be, but not necessarily, incoherent light.

The system that generates light may include more than one light source. The light collecting system may include more than one optical detector.

There is provided in accordance with an embodiment of the invention a method for classifying media, including the following steps generating one or more two-dimensional maps, each of the maps including the two dimensional map generated by the abovementioned system, feeding a neural network classification algorithm with the one or more two-dimensional maps, training the neural network by providing expert labelling to the classes generated by the neural network algorithm, and using the trained neural network in order to classify unknown media. The neural network may be combined with a reinforcement algorithm for continuous updating of new classes.

### BRIEF DESCRIPTION OF THE DRAWINGS

The present invention will be understood and appreciated more fully from the following detailed description taken in conjunction with the drawings in which:

FIG. 1 is a simplified schematic illustration of the apparatus in accordance with a non-limiting embodiment of the invention.

FIG. 2 is a simplified schematic illustration of an apparatus similar to the one in FIG. 1, except that the scanning of the detector is along a linear dimension.

FIG. 3 is a simplified schematic illustration of an apparatus similar to the one in FIG. 1, except that multiple light sources are turned on and off sequentially, thus providing the angular dependence.

FIG. 4 is a simplified graphic illustration of experimental results showing maps generated using different media. The illustrations are from top to bottom: pure water, water containing 0.003% milk and water containing 0.1% milk.

### DETAILED DESCRIPTION

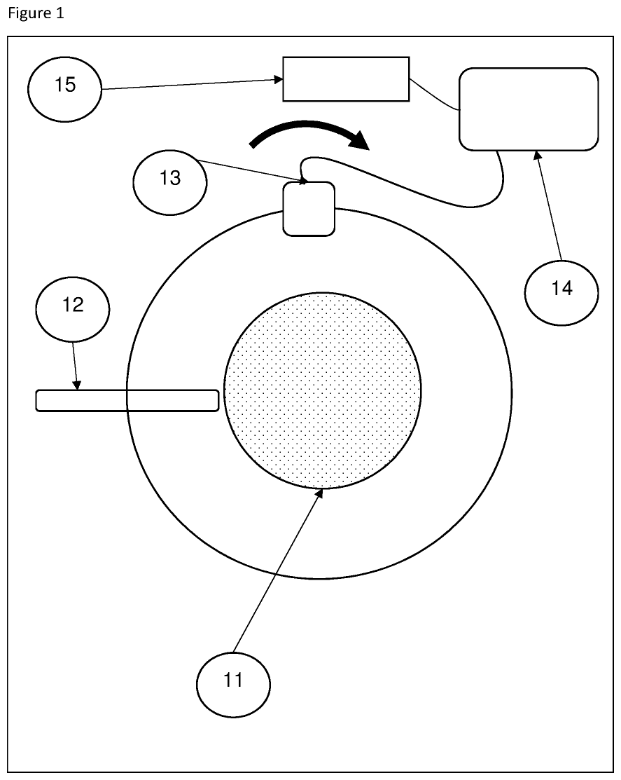

Reference is now made to FIG. 1.

An incoherent, wide spectrum light source 12, such as, but not limited to, a LED or a group of LEDs, is coupled in a turbid medium 11. Light in the medium is both scattered and absorbed. It is detected by a collecting optical detector 13. Detector 13 may be a collecting optical fiber where light is coupled therein using for example (but not necessarily) a lens. Light is then analyzed using a spectrometric system (or simply spectrometer) 14, such as without limitation, a fiber-coupled Hamamatsu micro-spectrometer.

The collecting optics detector 13 is rotationally scanned around the turbid medium so that for each angle a spectrogram is recorded. Conversely, the source can be rotated while the light collecting optics detector 13 is either stationary or rotating. The spectrum detected by detector 13 for each angle is recorded in a computing unit 15.

Alternatively, more than one light source 12 may be used and more than one detector 13 may be used. The light sources 12 may be spaced from each other, such as being angularly and/or linearly spaced from each other. Likewise, the detectors 13 may be spaced from each other, such as being angularly and/or linearly spaced from each other.

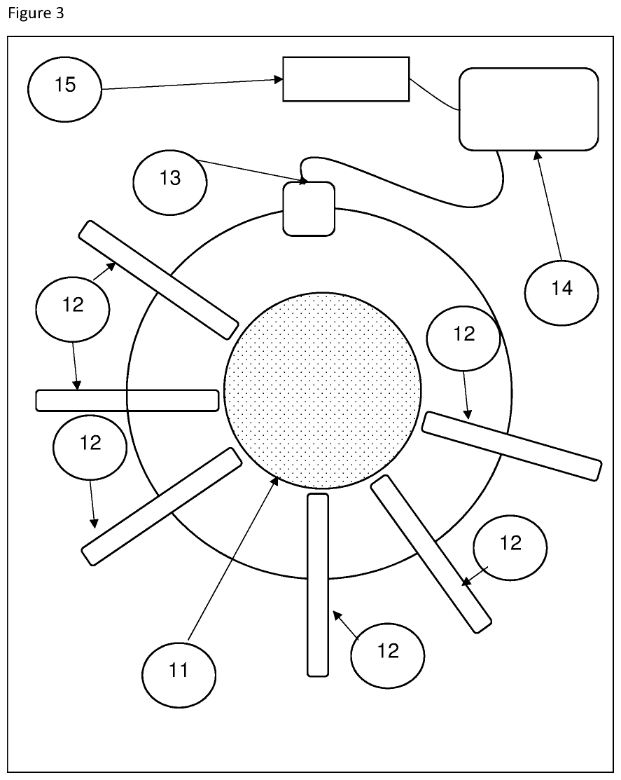

For example, in another embodiment, described in FIG. 3, multiple light sources 12 are turned on and off sequentially, thus providing the angular dependence, whereas the light collecting optics 12 is either stationary or rotating.

The computing unit 15 uses the different spectrograms obtained at the different angles in order to generate a two-dimensional map where one axis is the wavelength and the second one is the collecting angle.

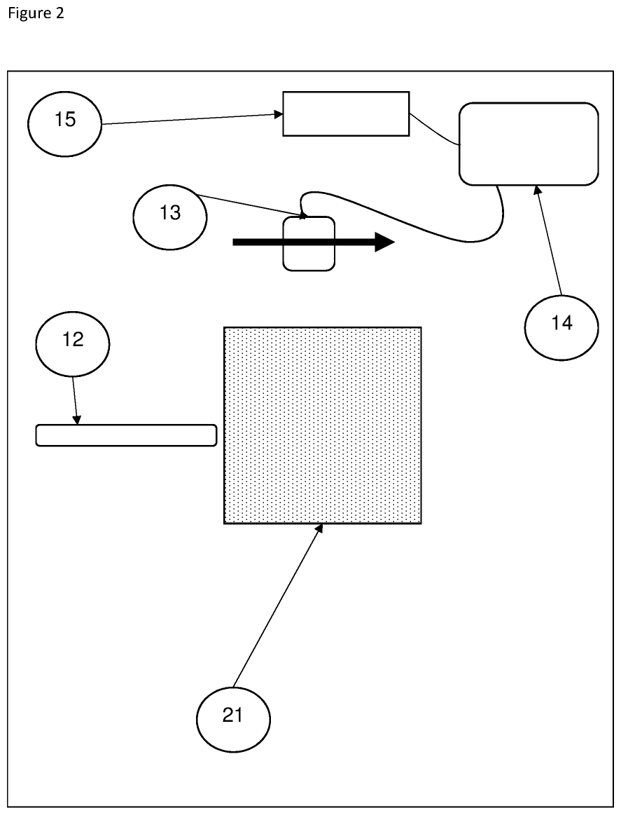

In another embodiment, described in FIG. 2, the detector 13 is moved linearly and the shape of the medium or container 21 holding the medium may be designed in order to avoid optical aberrations; avoiding optical aberrations can be alternatively incorporated within the image classification algorithm later in the mathematical processing.

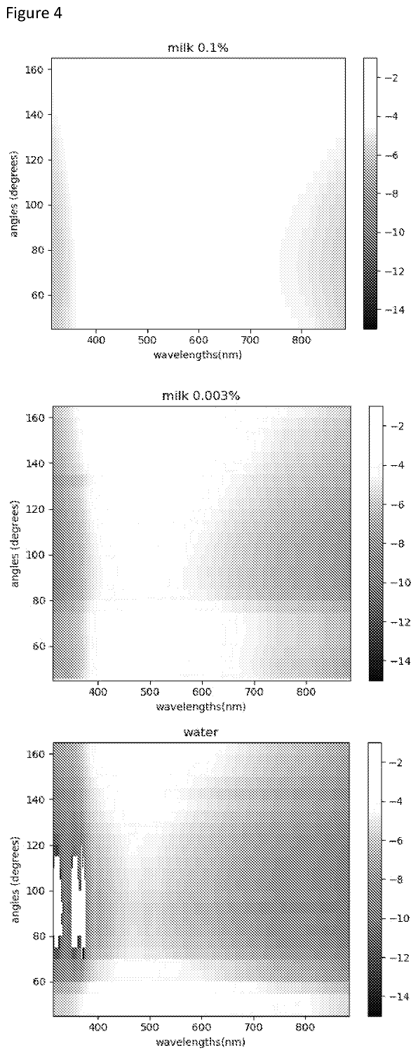

In FIG. 4, such a map has been experimentally determined for pure water, water with 0.003% milk and water with 0.1% milk. The three maps look clearly different with specific patterns.

An extension of the method is to determine the composition of the medium. The obtained map is similar to a picture, and therefore image classification algorithms such as convolutional neural networks (NN) can be applied. Different methods of machine learning can be applied in order to retrieve the medium composition. This necessitates first to train the recognition system. For that, different maps corresponding to different compositions are generated and are used for the NN training.

The objective of the algorithm is to classify the maps so that all the relevant information is extracted from these maps.

In the next stage, the classes discovered by the algorithm are labelled by the human expert so that each class corresponds to a specific piece of information. For example, such classes can be labelled as “Contains germs” or “Contains particles of size larger than 100 microns”.

Finally, the system can be used for the classification of unknown medium. Using the same apparatus as described above, an unknown medium is scanned. The map obtained is then used as an input of the trained classification algorithm, which generates the proper label.

It should be noted that the NN algorithm can be combined with a reinforcement NN algorithm so that new classes can be generated and labelled by a human expert.

In another aspect of the invention, instead of incoherent light, laser light may be used with laser light sources of different wavelengths. The laser light sources are spaced from one another.

In another aspect of the invention, in addition to wavelength and position of the light collecting system, other parameters may be detected/sensed and added to the analysis. For example, temporal information such as the time duration of the emitted light beam to be scattered and detected may also be used to analyze the composition of the turbid medium.

1. An apparatus for generating a two dimensional map representative of a turbid or clear medium, comprising:
a system that generates light within a medium;
a light collecting system that is movable relative to the medium being analyzed and that collects light exiting said medium; and
a spectrum analyzer configured to determine spectrum data of said light exiting the medium and to transmit the spectrum data to a computing unit, wherein said computing unit is configured to generate a two dimensional map, wherein one dimension of the map is wavelength and a second dimension is a position of said light collecting system.

2. The apparatus according to claim 1, wherein said light collecting system is movable along a curved path.

3. The apparatus according to claim 1, wherein the light collecting system is movable linearly.

4. The apparatus according to claim 1, wherein said light comprises incoherent light.

5. The apparatus according to claim 1, wherein said system that generates light comprises more than one light source.

6. The apparatus according to claim 1, wherein said light collecting system comprises more than one optical detector.

7. A method for classifying media, comprising the following steps:
generating one or more two-dimensional maps, each of said maps comprising said two dimensional map generated by the system of claim 1;
feeding a neural network classification algorithm with said one or more two-dimensional maps;
training said neural network by providing expert labelling to the classes generated by the neural network algorithm; and
using said trained neural network in order to classify unknown media.

8. The method according to claim 7, wherein the neural network is combined with a reinforcement algorithm for continuous updating of new classes.
